(19) United States
(12) Patent Application Publication
(10) Pub. No.: US 2019/0373814 A1
(43) Pub. Date: Dec. 12, 2019

(54) Debris Removal System for an Agricultural Harvester and Related Debris Removal Methods

(71) Applicant: CNH Industrial America LLC, New Holland, PA (US)

(72) Inventors: Craig E. Murray, Davenport, IA (US); Michael J. Matway, Litchfield, IL (US); William Lawson, Raceland, LA (US)

(21) Appl. No.: 16/466,857

(22) PCT Filed: Dec. 5, 2017
(86) PCT No.: PCT/US2017/064647

§ 371 Date: Jun. 5, 2019

Related U.S. Application Data
(60) Provisional application No. 62/429,931, filed on Dec. 5, 2016.

(51) Int. Cl. A01D 43/08; A01D 41/12; A01D 45/10

(52) U.S. Cl. CPC A01D 43/08; A01D 45/10; A01D 41/1252

(57) ABSTRACT

A debris removal system for an agricultural harvester may include a chopper assembly configured to chop harvested crops into billets; an elevator having an elevator inlet that receives a stream of billets from the chopper assembly; and an extractor positioned adjacent the elevator inlet that is configured to remove from the harvester debris separated from the billets. A fan assembly may be positioned between the chopper assembly and the elevator inlet and may include a fan and a fan discharge outlet. The fan assembly may blow a stream of air through the stream of billets and toward the extractor to separate the debris from the billets for removal by the extractor. Moreover, the fan has a diameter that is approximately twice a height of the fan discharge outlet. Other debris removal systems and methods for removing debris from harvested crops also are provided.

### FIELD OF THE INVENTION

The present subject matter relates generally to agricultural harvesters, such as sugar cane harvesters, and, more particularly, to a debris removal system for an agricultural harvester for removing debris from harvested crops and related methods for removing debris from the crops.

### BACKGROUND OF THE INVENTION

Typically, agricultural harvesters include one or more extractor fans to draw air through a stream of harvested crops, such as a stream of sugar cane billets, to separate and remove pieces of debris or thresh from the crops. Usually, a primary extractor having an extractor fan is positioned near an intake of an elevator that conveys crops toward a receiver collecting the crops, and a secondary extractor having an extractor fan is positioned near a discharge of the elevator. The secondary extractor therefore affects the harvester ballast, gross weight, and stability, as well as increases the elevator weight, requiring a more robust structure to support the increased weight. Additionally, the secondary extractor requires hydraulics and electrical controls, as well as a housing for its extractor fan, which increases the complexity and cost of the mechanical assembly. Moreover, current extractor designs generally require extractor fans to draw air through the stream of harvested crops, which is less efficient than blowing air through the crops to separate the debris from the crops.

Accordingly, an improved debris removal system for an agricultural harvester that incorporates a fan assembly to separate debris from crops for removal by an extractor would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a debris removal system for an agricultural harvester. The debris removal system comprises a chopper assembly configured to chop harvested crops into billets; an elevator having an elevator inlet that receives a stream of billets from the chopper assembly; and an extractor configured to remove from the harvester debris separated from the billets. The extractor is positioned adjacent the elevator inlet. Further, a fan assembly is positioned between the chopper assembly and the elevator inlet. The fan assembly includes a fan and a fan discharge outlet, and the fan assembly blows a stream of air through the stream of billets and toward the extractor to separate the debris from the billets for removal by the extractor. Moreover, the fan has a diameter that is approximately twice a height of the fan discharge outlet.

In another aspect, the present subject matter is directed to a debris removal system for an agricultural harvester. The debris removal system comprises a chopper assembly configured to chop harvested crops into billets. The chopper assembly discharges a stream of billets toward an elevator that conveys the billets away from the chopper assembly. The debris removal system further comprises an extractor configured to remove debris from the billets. The extractor has an extractor inlet for receipt of debris and an extractor outlet for directing the debris away from the harvester. The debris removal system also comprises a chassis supporting the chopper assembly and a fan assembly disposed on the chassis to blow a stream of air through the stream of billets and thereby separate the debris from the billets. The stream of air from the fan assembly is directed toward the extractor inlet to blow debris from the billets toward the extractor.

In still another aspect, the present subject matter is directed to a debris removal system for an agricultural harvester. The debris removal system comprises a chopper assembly configured to chop harvested crops into billets; an elevator having an elevator inlet that receives a stream of billets from the chopper assembly; and an extractor positioned adjacent the elevator inlet. The extractor has an extractor fan that generates a suction force to remove from the harvester debris separated from the billets. Further, a fan assembly is positioned between the chopper assembly and the elevator inlet, and the fan assembly blows a stream of air through the stream of billets and toward the extractor to separate the debris from the billets for removal by the extractor.

In yet another aspect, the present subject matter is directed to a method for removing debris from crops in an agricultural harvester. The method comprises directing crops toward an elevator of the harvester; blowing a stream of air through the crops to separate debris from the crops; and generating a suction force to remove the debris from the crops.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified, side view of one embodiment of an agricultural harvester in accordance with aspects of the present subject matter;

FIG. 2 illustrates a side view of a chopper assembly and an elevator assembly of the harvester shown in FIG. 1;

FIG. 3A illustrates a bottom view of the proximal end of the elevator assembly shown in FIG, 2;

FIG. 3B illustrates a schematic side view of the fan assembly shown in FIG. 3A;

FIG. 4 illustrates a side view of the chopper assembly and the elevator assembly of FIG. 2 in accordance with aspects of the present subject matter; and

FIG. 5 illustrates a flow diagram of one embodiment of a method for removing debris from crops in an agricultural harvester in accordance with aspects of the present subject matter.

FIGS. 6, 7, and 8 provide various views of a CAD model illustrating one embodiment of a fan assembly installed relative to components of a harvester in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a debris removal system for an agricultural harvester that includes a fan assembly for blowing a stream of air through harvested crops to separate debris from the crops for removal of the debris from the harvester. Specifically, in several embodiments, the fan assembly is positioned between a distal end of a chopper assembly, which chops the harvested crops into smaller pieces or billets, and an inlet of an elevator that conveys the billets toward, e.g., an external storage device. The fan assembly blows a stream of air through a stream of billets discharged from the chopper assembly at its distal end to separate debris from the billets. An extractor including an extractor fan preferably is positioned near the fan assembly to remove the debris from the harvester, e.g., by generating a suction or vacuum force that sucks the debris away from the billets and directing the debris away from the harvester. In other embodiments, the fan assembly may be positioned at different locations, for example, the fan assembly may be positioned at the outlet of the elevator to blow the stream of air through the billets before or as the billets are discharged from the harvester. In still other embodiments, the debris removal system may include multiple fan assemblies and/or multiple extractors. Each fan assembly helps separate the debris from the crop billets, and the debris may then be expelled from the harvester.

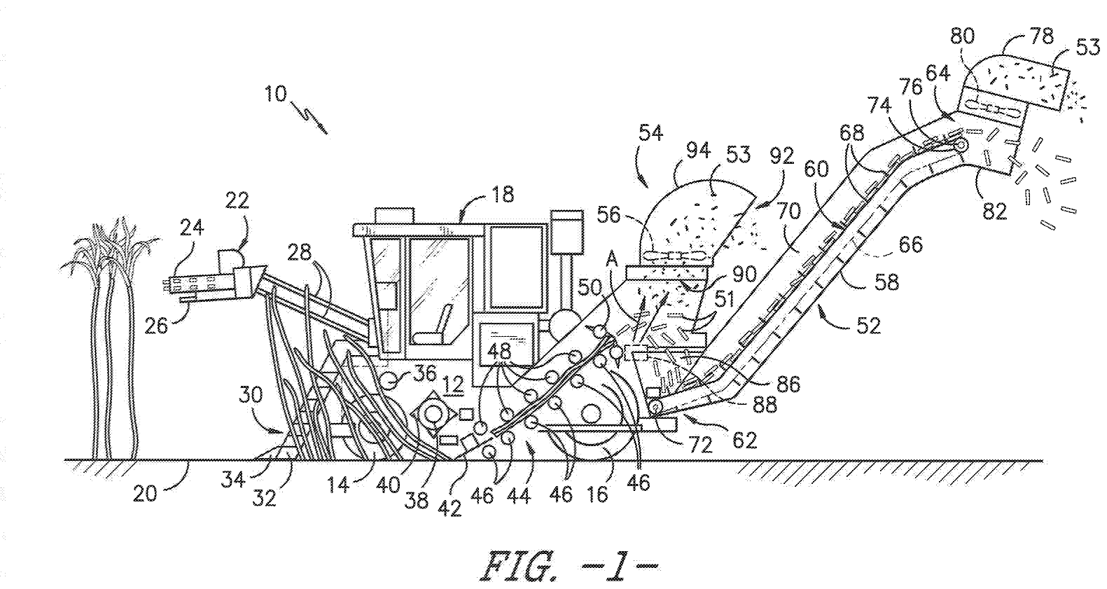

Referring now to the drawings, FIG. 1 illustrates a side view of one embodiment of an agricultural harvester 10 in accordance with aspects of the present subject matter. As shown, the harvester 10 is configured as a sugarcane harvester. However, in other embodiments, the harvester 10 may correspond to any other suitable agricultural harvester known in the art.

As shown in FIG. 1, the harvester 10 includes a frame 12, a pair of front wheels 14, a pair of rear wheels 16, and an operator's cab 18. The harvester 10 may also include a primary source of power (e.g., an engine mounted on the frame 12) which powers one or both pairs of the wheels 14, 16 via a transmission (not shown). Alternatively, the harvester 10 may be a track-driven harvester and, thus, may include tracks driven by the engine as opposed to the illustrated wheels 14, 16. The engine may also drive a hydraulic fluid pump (not shown) configured to generate pressurized hydraulic fluid for powering various hydraulic components of the harvester 10.

Additionally, the harvester 10 may include various components for cutting, processing, cleaning, and discharging sugar cane as the cane is harvested from an agricultural field 20. For instance, the harvester 10 may include a topper assembly 22 positioned at its front end to intercept sugar cane as the harvester 10 is moved in the forward direction. As shown, the topper assembly 22 may include both a gathering disk 24 and a cutting disk 26. The gathering disk 24 may be configured to gather the sugar cane stalks so that the cutting disk 26 may be used to cut off the top of each stalk. As is generally understood, the height of the topper assembly 22 may be adjustable via a pair of arms 28 hydraulically raised and lowered, as desired, by the operator.

Additionally, the harvester 10 may include a crop divider 30 that extends upwardly and rearwardly from the field 20. In general, the crop divider 30 may include two spiral feed rollers 32. Each feed roller 32 may include a ground shoe 34 at its lower end to assist the crop divider 30 in gathering the sugar cane stalks for harvesting. Moreover, as shown in FIG. 1, the harvester 10 may include a knock-down roller 36 positioned near the front wheels 14 and a fin roller 38 positioned behind the knock-down roller 36. As the knock-down roller 36 is rotated, the sugar cane stalks being harvested are knocked down while the crop divider 30 gathers the stalks from agricultural field 20. Further, as shown in FIG. 1, the fin roller 38 may include a plurality of intermittently mounted fins 40 that assist in forcing the sugar cane stalks downwardly. As the fin roller 38 is rotated during the harvest, the sugar cane stalks that have been knocked down by the knock-down roller 36 are separated and further knocked down by the fin roller 38 as the harvester 10 continues to be moved in the forward direction relative to the field 20.

Referring still to FIG. 1, the harvester 10 may also include a base cutter assembly 42 positioned behind the fin roller 30. As is generally understood, the base cutter assembly 42 may include blades (not shown) for severing the sugar cane stalks as the cane is being harvested. The blades, located on the periphery of the assembly 42, may be rotated by a hydraulic motor (not shown) powered by the vehicle's hydraulic system. Additionally, in several embodiments, the blades may be angled downwardly to sever the base of the sugar cane as the cane is knocked down by the fin roller 30.

Moreover, the harvester 10 may include a feed roller assembly 44 located downstream of the base cutter assembly 42 for moving the severed stalks of sugar cane from base cutter assembly 42 along the processing path. As shown in FIG. 1, the feed roller assembly 44 may include a plurality of bottom rollers 46 and a plurality of opposed, top pinch rollers 48. The various bottom and top rollers 46, 48 may be used to pinch the harvested sugar cane during transport. As the sugar cane is transported through the feed roller assembly 44, debris (e.g., rocks, dirt, and/or the like) may be allowed to fall through bottom rollers 46 onto the field 20.

In addition, the harvester 10 may include a chopper assembly 50 located at the downstream end of the feed roller assembly 44 (e.g., adjacent to the rearward-most bottom and top feed rollers 46, 48). In general, the chopper assembly 50 may be used to cut or chop the severed sugar cane stalks into pieces or “billets” 51, which may be, for example, six (6) inches long. The billets 51 may then be propelled towards an elevator assembly 52 of the harvester 10 for delivery to an external receiver or storage device (not shown).

As is generally understood, pieces of debris 53 (e.g., dust, dirt, leaves, etc.) separated from the sugar cane billets 51 may be expelled from the harvester 10 through a primary extractor 54, which is located behind the chopper assembly 50 and is oriented to direct the debris 53 outwardly from the harvester 10, Additionally, an extractor fan 56 may be mounted at the base of the primary extractor 54 for generating a suction force or vacuum sufficient to pick up the debris 53 and force the debris 53 through the primary extractor 54. The separated or cleaned billets 51, heavier than the debris 53 being expelled through the extractor 54, may then fall downward to the elevator assembly 52.

As shown in FIG. 1, the elevator assembly 52 may generally include an elevator housing 58 and an elevator 60 extending within the elevator housing 58 between a lower, proximal end 62 and an upper, distal end 64. In general, the elevator 60 may include a looped chain 66 and a plurality of flights or paddles 68 attached to and evenly spaced on the chain 66. The paddles 68 may be configured to hold the sugar cane billets 51 on the elevator 60 as the billets are elevated along a top span 70 of the elevator 70 defines between its proximal and distal ends 62, 64. Additionally, the elevator 60 may include lower and upper sprockets 72, 74 positioned at its proximal and distal ends 62, 64, respectively. As shown in FIG. 1, an elevator motor 76 may be coupled to one of the sprockets (e.g., the upper sprocket 74) for driving the chain 66, thereby allowing the chain 66 and the paddles 68 to travel in an endless loop between the proximal and distal ends 62, 64 of the elevator 60.

Moreover, in some embodiments, pieces of debris 53 (e.g., dust, dirt, leaves, etc.) separated from the elevated sugar cane billets 51 may be expelled from the harvester 10 through a secondary extractor 78 coupled to the rear end of the elevator housing 58. For example, the debris 53 expelled by the secondary extractor 78 may be debris remaining after the billets 51 are cleaned and debris 53 expelled by the primary extractor 54. As shown in FIG. 1, the secondary extractor 78 may be located adjacent to the distal end 624 of the elevator 60 and may be oriented to direct the debris 53 outwardly from the harvester 10. Additionally, an extractor fan 80 may be mounted at the base of the secondary extractor 78 for generating a suction force or vacuum sufficient to pick up the debris 53 and force the debris 53 through the secondary extractor 78. The separated, cleaned billets 51, heavier than the debris 53 expelled through the extractor 78, may then fall from the distal end 64 of the elevator 60. Typically, the billets 51 may fall downwardly through an elevator discharge opening 82 of the elevator assembly 52 into an external storage device (not shown), such as a sugar cane billet cart. As described in greater detail below, in other embodiments, the secondary extractor 78 may be omitted, such that the primary extractor 54 extracts debris 53 from the billets 51, which then travel via elevator 60 to its distal end 64, where the billets may fall downwardly through the elevator discharge opening 82 into the external storage device.

During operation, the harvester 10 is traversed across the agricultural field 20 for harvesting sugar cane. After the height of the topper assembly 22 is adjusted via the arms 28, the gathering disk 24 on the topper assembly 22 may function to gather the sugar cane stalks as the harvester 10 proceeds across the field 20, while the cutter disk 26 severs the leafy tops of the sugar cane stalks for disposal along either side of harvester 10. As the stalks enter the crop divider 30, the ground shoes 34 may set the operating width to determine the quantity of sugar cane entering the throat of the harvester 10. The spiral feed rollers 32 then gather the stalks into the throat to allow the knockdown roller 36 to bend the stalks downwardly in conjunction with the action of the fin roller 38. Once the stalks are angled downwardly as shown in FIG. 1, the base cutter assembly 42 may then sever the base of the stalks from field 20. The severed stalks are then, by movement of the harvester 10, directed to the feed roller assembly 44.

The severed sugar cane stalks are conveyed rearwardly by the bottom and top feed rollers 46, 48, which compress the stalks, make them more uniform, and shake loose debris to pass through the bottom rollers 46 to the field 20. At the downstream end of the feed roller assembly 44, the chopper assembly 50 cuts or chops the compressed sugar cane stalks into pieces or billets 51 (e.g., 6 inch cane sections). Airborne debris or chaff 53 (e.g., dust, dirt, leaves, etc.) separated from the sugar cane billets is then extracted through the primary extractor 54 using suction created by the extractor fan 56. The separated/cleaned billets 51 then fall downwardly into the elevator assembly 52 and travel upwardly via the elevator 60 from its proximal end 62 to its distal end 64. During normal operation, once the billets 51 reach the distal end 64 of the elevator 60, the billets 51 fall through the elevator discharge opening 82 to an external storage device. If provided, the secondary extractor 78 (with the aid of the extractor fan 80) blows out chaff 53 from harvester 10, similar to the primary extractor 54.

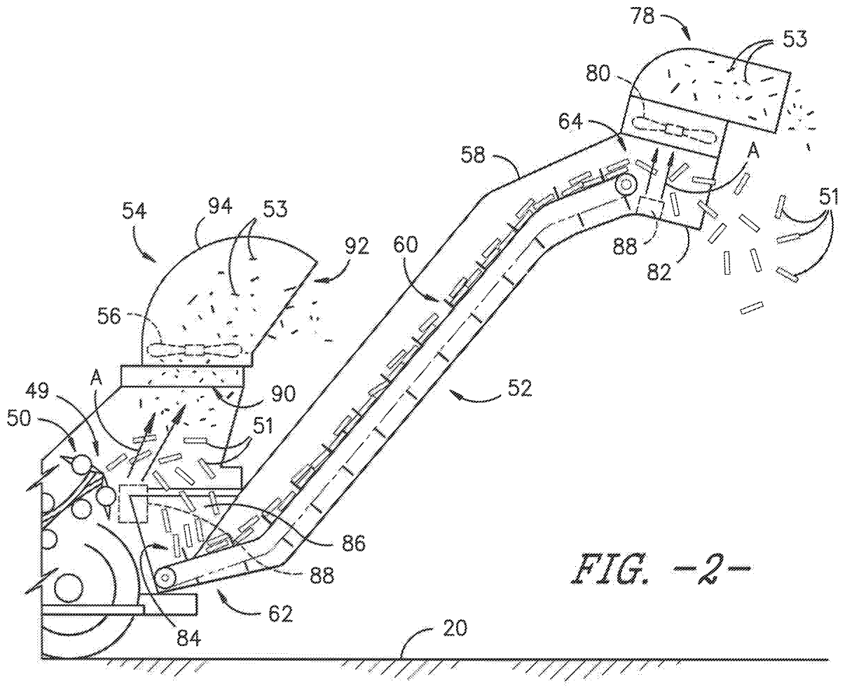

Referring to FIGS. 1 and 2, the elevator housing 58 defines an elevator inlet 84 at or near its lower, proximal end 62. The billets 51 may be propelled from the chopper assembly 50 generally as a stream of billets B, and the elevator inlet 84 receives the stream of billets B. More particularly, an elevator hopper 86 may be positioned adjacent the elevator inlet such that the elevator hopper 86 receives the stream of billets B and directs the stream of billets B to the elevator inlet 84. The billets 51 fall downwardly through the elevator inlet 84 into the elevator assembly 52 and then travel upwardly via the elevator 60 as described above. Further, the primary extractor 54 is positioned adjacent the elevator inlet 84, e.g., vertically above the elevator inlet 84 as shown in FIGS. 1 and 2. As such, the extractor 54 may remove debris 53 from the billets 51 before the billets enter the elevator assembly 52.

In the depicted embodiment, the extractor 54 is a portion of a debris removal system that separates debris 53 from the billets 51 and removes the debris 53 from the harvester 10. As illustrated in FIGS. 1 and 2, a fan assembly 88 is positioned between the chopper assembly 50 and the elevator inlet 84 and, more specifically, is positioned between a distal end 49 of the chopper assembly 50 and the elevator hopper 86. The fan assembly 88 blows a stream of air A through the stream of billets B and thereby separates the debris 53 from the billets 51 for removal by the extractor 54. As such, the fan assembly 88 is another portion of the debris removal system, In some embodiments, the fan assembly 88 blows the stream of air A toward an extractor inlet 90 of the extractor 54 to thereby blow the debris 53 separated from the billets 51 toward the extractor 54 for extraction from the harvester 10. The debris 53 extracted by extractor 54 is directed out of and away from harvester 10 as previously described, e.g., through an extractor outlet 92 defined by a shaped hood 94. For instance, the hood 94 may be shaped to direct the debris 53 away from the harvester 10,

As depicted in FIG. 2, a fan assembly 88 also may be positioned at or near the distal end 64 of elevator 60 such that the fan assembly 88 is positioned near the secondary extractor 78 and the elevator discharge opening 82. Similar to the fan assembly 88 positioned near the elevator inlet 84, the fan assembly 88 positioned near the elevator discharge opening 82 blows a stream of air A through the billets 51 and thereby separates the debris 53 from the billets 51 for removal by the secondary extractor 78. In some embodiments, the distal fan assembly 88 blows the stream of air A toward an extractor inlet of the secondary extractor 78 to thereby blow the debris 53 separated from the billets 51 toward the extractor 78 for extraction from the harvester 10. The debris 53 extracted by extractor 78 is directed out of and away from harvester 10 as previously described, e.g., through an extractor outlet defined by a shaped hood, which may be shaped to direct the debris 53 away from the harvester 10.

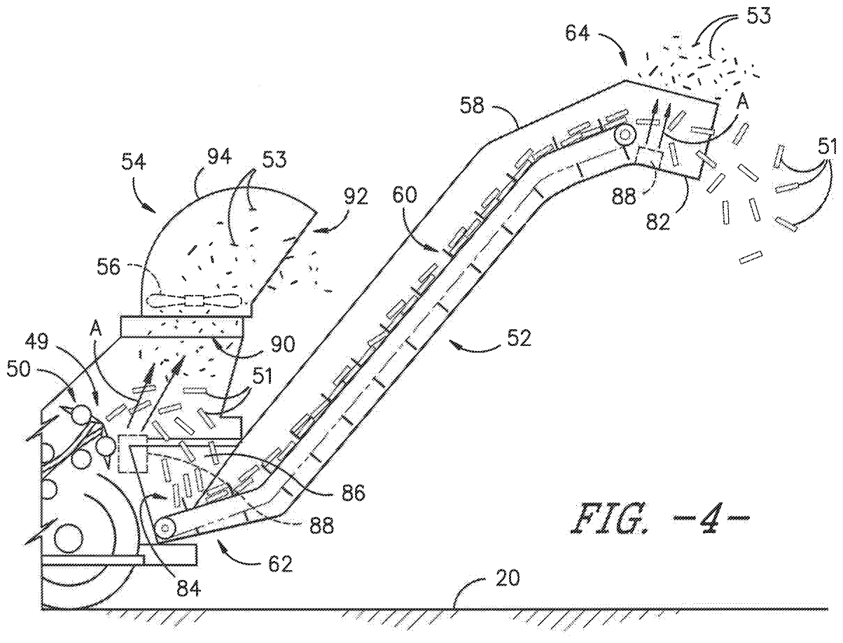

It will be appreciated that, in other embodiments, the distal fan assembly 88 may be omitted such that the debris removal system comprises the proximal fan assembly 88 (positioned near the proximal end 62 of elevator 60), the primary extractor 54, and the secondary extractor 78. In yet other embodiments, as described below with respect to FIG. 4, the secondary extractor 78 may be omitted such that the debris removal system comprises the proximal fan assembly 88, the primary extractor 54, and the distal fan assembly 88. In still other embodiments, both the secondary extractor 78 and the distal fan assembly 88 may be omitted such that the debris removal system comprises only the proximal fan assembly 88 and the primary extractor 54. In other configurations, either or both of the proximal fan assembly 88 and the primary extractor 54 may be omitted while either or both of the distal fan assembly 88 and the secondary extractor 78 are provided to separate and remove the debris 53 from the billets 51. Still other configurations of the debris removal system and harvester 10, e.g., comprising multiple fan assemblies 88 and/or multiple extractors, may be used as well.

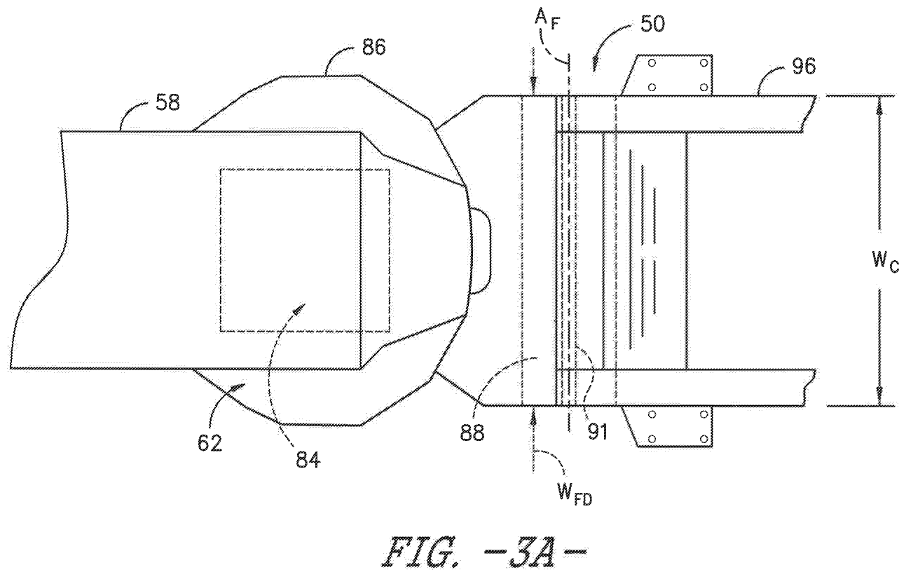

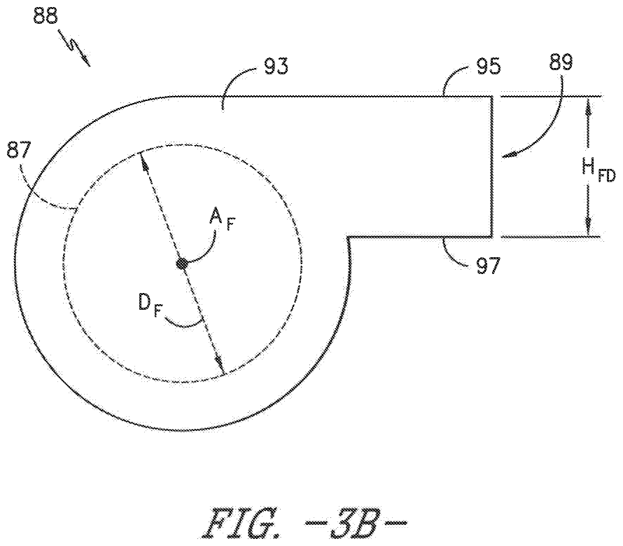

Referring to FIGS. 3A and 3B, the fan assembly 88 will be described in greater detail. FIG. 3A illustrates a bottom view of the proximal end 62 of the elevator assembly 52 shown in FIG. 2, with the fan assembly 88 positioned adjacent to the proximal end 62 in accordance with aspects of the present subject matter. FIG. 3B illustrates a schematic side view of the fan assembly 88 of FIG. 3A in accordance with aspects of the present subject matter.

In the depicted exemplary embodiment, the fan assembly 88 includes a fan 87 and a fan discharge outlet 89. An elongated shaft 91 defines a rotational axis A_{F} of the fan 87. Opposite ends of the shaft 91 may be rotatably received in bearing assemblies (not shown) that are carried by opposed end walls of a fan housing 93, which effectively closes the sides of the fan 87. In other embodiments, the fan assembly 88 may not be provided with a dedicated fan housing 93 but, instead, the chassis 96 or another suitable component of the harvester 10 may support the shaft 91 and close the sides of the fan 87 as needed. Further, in some embodiments, the fan assembly 88 may include a variable speed fan drive, e.g., that permits a harvester operator to adjust fan speed from the operator's cab 18. As will be appreciated, the fan 87 may be, e.g., a centrifugal fan or other suitable fan for blowing air through the stream of billets B to separate debris 53 from the billets 51.

As most clearly shown in FIG. 3A, the fan assembly 88 is disposed on a chassis 96 that helps support the chopper assembly 50. More specifically, the fan assembly 88 is transversely mounted on the chassis 96 behind the chopper assembly 50 near its distal end 49 and forward of the elevator assembly 52. The chassis 96 has a width W_{C}, and the fan discharge outlet 89 has a width W_{FD}. In the illustrated embodiment, the fan assembly 88 extends widthwise on the chassis 96 and, more particularly, extends transversely across substantially the entire width of the chassis 96 such that the width W_{FD} of the fan discharge outlet 89 is substantially equal to the width W_{C} of the chassis 96. In general, the width W_{FD} of fan discharge outlet 89 is at most equal to the width W_{C} of the chassis 96. That is, the width W_{FD} of the fan discharge outlet 89 is less than or equal to the width W_{FD} of the chassis 96. However, it will be appreciated that the fan discharge outlet 89 may have any appropriate width W_{FD}. For example, the width W_{FD} of fan discharge outlet 89 may depend on the size of fan 87 needed to separate the debris 53 from the billets 51, or the width W_{FD} of fan discharge outlet 89 generally may by constrained by the width W_{C} of the chassis 96 as described above. The width W_{FD} of the fan discharge outlet 89 may be within a range of about 700 millimeters to about 1000 millimeters. For example, in one exemplary embodiment, the width W_{FD} of the fan discharge outlet 89 may be approximately 900 millimeters, and in another exemplary embodiment, the width W_{FD} of the fan discharge outlet 89 may be about 800 millimeters, However, other widths W_{FD} may be used as well.

Further, the fan discharge outlet 89 extends parallel to and along substantially the entire length of the fan 87 for directing air discharged from the fan toward the stream of billets. As depicted in FIG. 3B, the fan discharge outlet 89 includes an upper baffle 95 and a lower baffle 97, which direct the air discharged from the fan 87. It will be appreciated that the upper and lower air directing baffles 95, 97 are formed from a material such as sheet metal that is impervious to the passage of air. As such, the upper and lower baffles 95, 97 direct the stream of air F discharged from the fan assembly 88 through the stream of billets B as shown in FIGS. 1 and 2.

Moreover, the upper baffle 95 and the lower baffle 97 define a height H_{FD} of the fan discharge outlet 89. The height H_{FD} of the fan discharge outlet 89 may be within a range of about 50 millimeters to about 100 millimeters; in one exemplary embodiment, the height H_{FD} is approximately 75 millimeters. The height H_{FD} and the width W_{FD} of the fan discharge outlet 89 define a cross-sectional area of the fan discharge outlet 89. Further, as shown in FIG. 3B, the fan 87 has a diameter D_{F}. The fan diameter D_{F} may be within a range of about 100 millimeters to about 200 millimeters; for example, the D_{F} diameter may be approximately 150 millimeters.

In some embodiments, the height H_{FD} of the fan discharge outlet 89 may be related to the diameter D_{F} of the fan 87. In one exemplary embodiment, the diameter D_{F} of the fan 87 is approximately one-and-a-half (1.5) to four (4) times the height H_{FD} of the fan discharge outlet 89. Stated differently, the fan discharge outlet 89 may have a height H_{FD} that is approximately one-quarter (¼) to two-thirds ( ⅔) the diameter D_{F} of the fan 87. For example, in one embodiment, the fan 87 may have a diameter of about 100 millimeters, and the height H_{FD} of the fan discharge outlet 89 may be about 25 millimeters. In another exemplary embodiment, the diameter D_{F} of the fan 87 is approximately twice or two times the height H_{FD} of the fan discharge outlet 89. Stated differently, the fan discharge outlet 89 may have a height H_{FD} that is approximately half the diameter D_{F} of the fan 87. For example, in one embodiment, the fan 87 may have a diameter is about 150 millimeters, and the height H_{FD} of the fan discharge outlet 89 is about 75 millimeters. Of course, the height H_{FD} may have other relationships to the diameter D_{F}, or the width W_{FD} and/or the cross-sectional area of the fan discharge outlet 89 may be related to the diameter D_{F} of the fan 87.

Turning now to FIG. 4, a side view of the chopper assembly 50 and the elevator assembly 52 shown in FIG. 2 is illustrated in accordance with aspects of the present subject matter. As described above, in some embodiments, the secondary extractor 78 may be omitted. For example, the fan assembly 88 positioned near the elevator inlet 62 may increase an extraction efficiency of the primary extractor 54 such that the secondary extractor 78 is not needed to remove remaining debris 53 from the billets 51. As such, the secondary extractor 78 and its associated extractor fan 80 may be omitted from the distal end 64 of the elevator 60.

As shown in FIG. 4, rather than a secondary extractor 78, a fan assembly 88 is positioned at the distal end 64 of the elevator 60. In some embodiments, the fan assembly 88 may be positioned at the distal end 64 rather than adjacent the elevator inlet 84 defined at or near the proximal end 62 of the elevator 60. In other embodiments, a fan assembly 88 may be positioned near both the proximal end 62 and the distal end 64. Including a fan assembly 88 at or near the elevator discharge 82 may, e.g., increase cleaning efficiency and/or eliminate the need for a secondary extractor 78 at or near the elevator discharge.

It will be appreciated that the fan assembly 88 at distal end 64 directs the stream of air A through the billets 51 just before or as the billets 51 are discharged from the elevator 60 through the elevator discharge opening 82, As previously described, the stream of air A separates pieces of debris 53 (e.g., dust, dirt, leaves, etc.) from the billets 51. The elevator housing 58 at the distal end 64 may define one or more apertures (not shown) through which the debris 53 is directed away from the harvester 10 and the billets 51 falling into an external storage device. Further, the fan assembly 88 may be positioned widthwise across the elevator housing 58 at the distal end 64 such that the width W_{FD} of the fan discharge outlet 89 of the distal fan assembly 88 is extending into the page with respect to FIG. 4. The fan discharge outlet may have any suitable width W_{FD}, but in some embodiments, the width W_{FD} is at most the width of the elevator housing 58 at distal end 64. Moreover, a fan assembly 88 positioned at the distal end 64 may be scaled with respect to a fan assembly 88 positioned at the proximal end 62, e.g., the fan diameter D_{F} and fan discharge outlet dimensions W_{FD}, H_{FD} of the distal fan assembly 88 may be a fraction or percentage of the values of the dimensions of the proximal fan assembly 88 stated above.

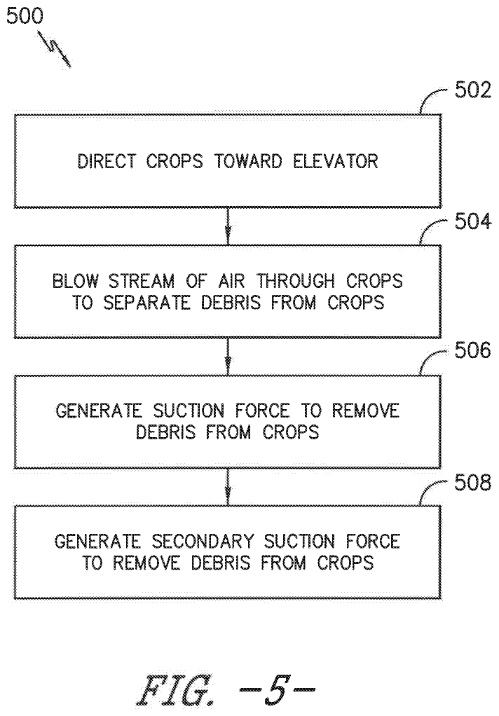

Referring now to FIG. 5, a flow diagram of one embodiment of a method 500 for removing debris from crops in an agricultural harvester is illustrated in accordance with aspects of the present subject matter, In general, the method 500 will be described herein with reference to the embodiments of the harvester 10 described above with reference to FIGS. 1-4. However, it should be appreciated by those of ordinary skill in the art that the disclosed method 500 may generally be implemented with any harvester 10 having any suitable harvester configuration. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (502), the method 500 may include directing crops toward an elevator of the harvester 10. As described above, once the base of the crops is severed from field 20, the severed crops are directed to the feed roller assembly 44 by movement of the harvester 10. At the downstream end of the feed roller assembly 44, the chopper assembly 50 cuts or chops the crops into pieces or billets 51 (e.g., smaller sugar cane sections such as six inch sections). The crop billets 51 are then directed toward the elevator inlet 84 of the elevator 60, which conveys the billets toward an external storage device and away from the harvester 10.

As the crops are directed toward the elevator 60, the method 500 includes, at (504), blowing a stream of air A through the crops to separate debris 53 from the crops. More particularly, as previously described, a fan assembly 88 blows the stream of air A through the stream of billets 51 discharged from the chopper assembly 50 to separate debris 53 from the billets 51. The method 500 further includes, at (506), generating a suction force to remove the debris 53 from the crops. For example, an extractor 54 may be positioned adjacent the elevator inlet 84 near the proximal end 62 of the elevator 60. An extractor fan 56 may be mounted at the base of the extractor 54, e.g., adjacent the extractor inlet 90, for generating a suction force or vacuum sufficient to pick up the debris 53 and force the debris 53 through the extractor 54. Thus, the suction force may be generated near the proximal end 62 of the elevator 60. Further, in some embodiments, the fan assembly 88 blows the stream of air A toward the extractor 54 for removal of the debris 53 from the harvester 10.

In some embodiments, the method 500 may include, at (508), generating a secondary suction force to remove the debris 53 from the crops. As an example, a secondary extractor 78, utilizing an extractor fan 80 to generate a suction force or vacuum sufficient to pick up the debris 53 and force the debris 53 through the extractor 78, may be provided at the distal end 64 of the elevator 60. The secondary suction force may remove any remaining debris 53 from the billets 51, e.g., before the billets 51 are discharged into an external storage device.

In other embodiments, the fan assembly 88 may be positioned near the distal end 64 of the elevator 60 rather than near the proximal end 62, such that the method 500 includes generating a suction force to remove debris from the crops and then blowing a stream of air through the crops to separate additional debris from the crops. More particularly, the extractor 54 positioned adjacent the proximal end 62 may remove debris 53 from the billets 51 as described above. The fan assembly 88 may be positioned near the distal end 64 and blows the stream of air A is directed through the billets 51 before or as the billets 51 are discharged from the elevator 60, such that the fan assembly 88 separates any remaining debris 53 from the billets 51 before the billets 51 are collected by an external storage device.

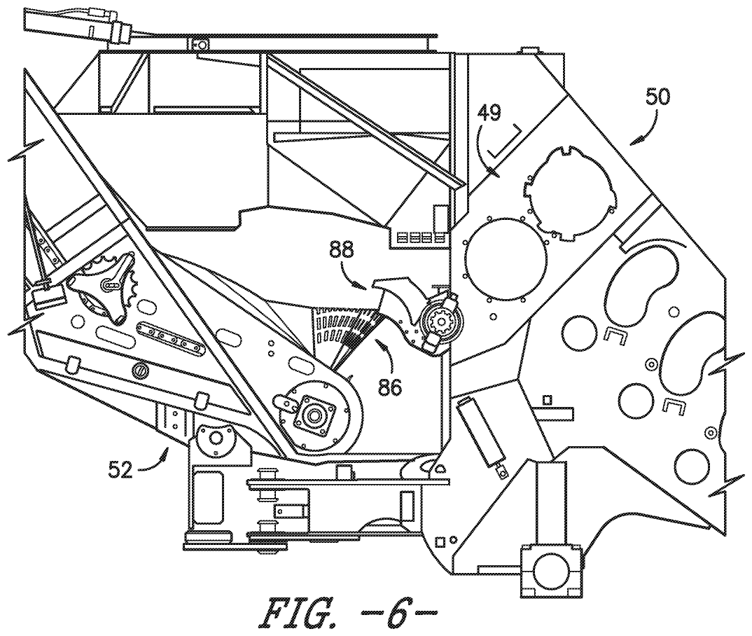

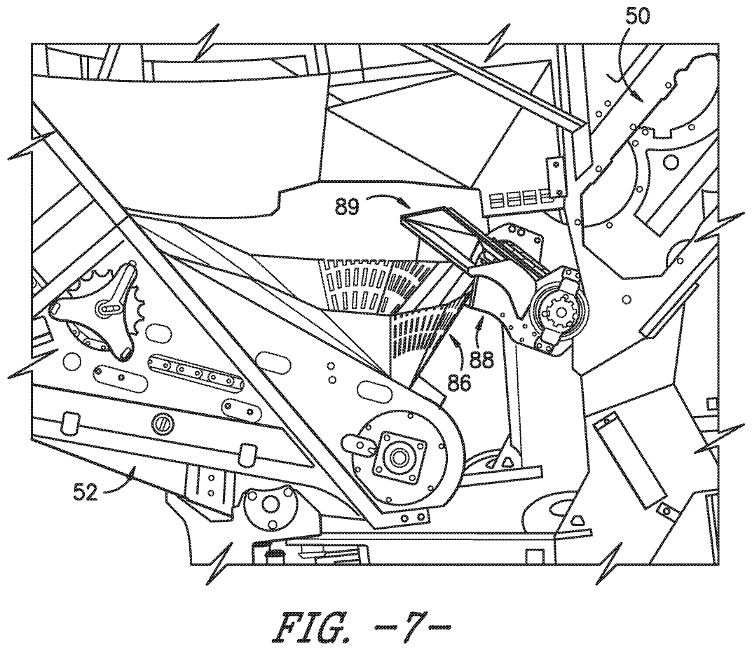

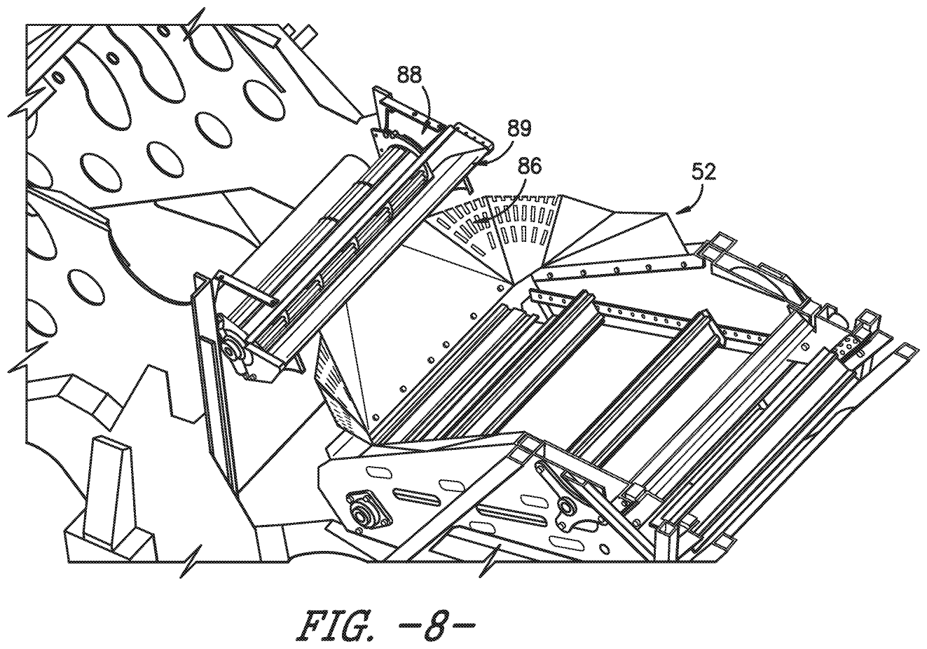

Referring now to FIGS. 6-8, several views of a CAD model illustrating one embodiment of a fan assembly 88 installed relative to various components of a harvester 10 are illustrated in accordance with aspects of the present subject matter. Specifically, FIG. 6 illustrates a side view of the CAD model illustrating the fan assembly 88 installed between the location at which the chopper assembly is configured to be positioned (indicated as 50 in FIG. 6) and the elevator assembly (indicated as 52 in FIG. 6). Additionally, FIG. 7 illustrates a first perspective view of the fan assembly 88 shown in FIG. 6 and FIG. 8 illustrates a second perspective view of the fan assembly 88 shown in FIG. 6. As shown, the fan assembly 88 is mounted between the chopper assembly 50 and the elevator assembly 52 to direct a stream of air A from below the chopper assembly 50 through the stream of billets discharged from the distal end 49 of the chopper assembly. Specifically, as shown in FIGS. 6 and 7, the fan assembly 88 may, in one embodiment, by mounted between the chopper assembly 50 and the elevator assembly 52 at a location directly adjacent to the inlet of the elevator hopper 86. For instance, as shown in FIG. 6-8, the fan discharge outlet 89 of the fan assembly 88 may be positioned directly above a top edge of the elevator hopper 86 forming the hopper inlet such that the fan assembly 88 is configured to generate a stream of air that passes through the stream of billets traveling between the chopper assembly 50 and the elevator hopper 86. For example, in the view of FIG. 7, the stream of air discharged from the fan discharge outlet 89 may be directed upwardly through the stream of billets passing over the fan assembly 88.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A debris removal system for an agricultural harvester, comprising:
a chopper assembly configured to chop harvested crops into billets;
an elevator having an elevator inlet that receives a stream of billets from the chopper assembly; and
an extractor configured to remove from the harvester debris separated from the billets, the extractor positioned adjacent the elevator inlet,
wherein a fan assembly is positioned between the chopper assembly and the elevator inlet, the fan assembly including a fan and a fan discharge outlet,
wherein the fan assembly blows a stream of air through the stream of billets and toward the extractor to separate the debris from the billets for removal by the extractor, and
wherein the fan has a diameter that is approximately twice a height of the fan discharge outlet.

2. The debris removal system of claim 1, further comprising a chassis supporting the chopper assembly, and wherein the fan assembly is disposed on the chassis.

3. The debris removal system of claim 2, wherein the chassis has a width, and wherein the width of the fan discharge outlet has is substantially equal to the width of the chassis.

4. The debris removal system of claim 1, further comprising an elevator hopper than receives the stream of billets from the chopper assembly and directs the stream of billets to the elevator inlet, and wherein the fan assembly is positioned between the chopper and the elevator hopper.

5. The debris removal system of claim 1, wherein the extractor comprises an extractor inlet, and wherein the fan assembly blows the stream of air toward the extractor inlet.

6. The debris removal system of claim 1, wherein the elevator further comprises an elevator discharge opening, and wherein a secondary extractor is positioned adjacent the elevator discharge opening to remove remaining debris from the billets.

7. A debris removal system for an agricultural harvester, comprising:
a chopper assembly configured to chop harvested crops into billets, the chopper assembly discharging a stream of billets toward an elevator that conveys the billets away from the chopper assembly:
an extractor configured to remove debris from the billets, the extractor having an extractor inlet for receipt of debris and an extractor outlet for directing the debris away from the harvester,
a chassis supporting the chopper assembly, and
a fan assembly disposed on the chassis to blow a stream of air through the stream of billets and thereby separate the debris from the billets, the fan assembly having a fan and a fan discharge outlet,
wherein the stream of air from the fan assembly is directed toward the extractor inlet to blow debris from the billets toward the extractor, and
wherein the fan discharge outlet has a width that is substantially equal o the width of the chassis.

8. The debris removal system of claim 7, wherein the elevator comprises an elevator inlet for receipt of the stream of billets, and wherein the fan assembly is positioned between the chopper assembly and the elevator inlet.

9. The debris removal system of claim 8, wherein the extractor is positioned adjacent the elevator inlet.

10. The debris removal system of claim 9, wherein the elevator conveys the billets to an elevator discharge opening to discharge the billets from the harvester, and wherein a secondary extractor is positioned adjacent the elevator discharge opening to remove remaining debris from the billets.

11. The debris removal system of claim 8, further comprising an elevator hopper for directing the billets to the elevator inlet, and wherein the fan assembly is positioned to blow the stream of air between the chopper assembly and the elevator hopper.

12. The debris removal system of claim 7, wherein the elevator conveys the billets to an elevator discharge opening to discharge the billets from the harvester, and wherein the fan assembly is positioned adjacent the elevator discharge opening to blow the stream of air through the billets being discharged from the harvester.

13. The debris removal system of claim 7, wherein the extractor comprises an extractor fan.

14. The debris removal system of claim 13, wherein the extractor fan generates a suction force to remove debris separated by the stream of air from the fan assembly.

15. The debris removal system of claim 7, wherein the fan assembly comprises a fan and a fan discharge outlet, and wherein the fan is a centrifugal fan.

16. A debris removal system for an agricultural harvester, comprising:
a chopper assembly configured to chop harvested crops into billets;
an elevator having an elevator inlet that receives a stream of billets from the chopper assembly; and
an extractor positioned adjacent the elevator inlet, the extractor having an extractor fan that generates a suction force to remove from the harvester debris separated from the billets,
wherein a fan assembly is positioned between the chopper assembly and the elevator inlet, and
wherein the fan assembly blows a stream of air through the stream of billets and toward the extractor to separate the debris from the billets for removal by the extractor.

17. A method for removing debris from crops in an agricultural harvester, comprising:
directing crops toward an elevator of the harvester;
blowing a stream of air through the crops to separate debris from the crops; and
generating a suction force to remove the debris from the crops.

18. The method of claim 17, wherein an extractor fan of an extractor generates the suction force.

19. The method of claim 17, wherein the suction force is generated near a proximal end of the elevator.

20. The method of claim 19, further comprising generating a secondary suction force near a distal end of the elevator to remove remaining debris from the crops.
